(19) United States
(12) Patent Application Publication
(10) Pub. No.: US 2021/0064615 A1
(43) Pub. Date: Mar. 4, 2021

(54) MEMORY SYSTEM QUERY WITH EXPANDING REQUEST

(71) Applicant: Mentor Graphics Corporation, Wilsonville, OR (US)

(72) Inventors: Caleb Bauermeister, Canby, OR (US); Eric E. Thompson, Portland, OR (US); Darcy J. McCallum, Portland, OR (US)

(21) Appl. No.: 16/556,502

(22) Filed: Aug. 30, 2019

(51) Int. Cl. G06F 16/2458; G06F 16/22; G06F 16/28; G06F 3/06

(52) U.S. Cl. CPC G06F 16/2458; G06F 16/2282; G06F 3/0607; G06F 3/0659; G06F 3/067; G06F 16/28

(57) ABSTRACT

This application discloses a server configured to receive an expanding memory access request for nested data stored in a memory system having multiple relational tables. The expanding memory access request identifies the relational tables storing the nested data and has a syntax that indicates links between the relational tables storing the nested data. The server parses the expanding memory access request to identify the links between the relational tables that store the nested data, and generates memory access commands based on the identified links. The memory access commands, when provided to the memory system, prompt the memory system to retrieve the nested data from the relational tables for the server. The server generates a response message that includes the nested data in a format specified in the expanding memory access request and transmits the response message to a client device that issued the expanding memory access request to the server.

### TECHNICAL FIELD

This application is generally related to memory system access and, more specifically, to memory system query with expanding request.

### BACKGROUND

Many memory systems implement relational databases to store and access data based on a relational model, for example, using a Structured Query Language (SQL) for querying and maintaining the relational databases. The relational databases utilizing the relational model organize data into tables having a row-column format, with each row having a unique key for a particular table. The columns of the table, often called attributes, can store data corresponding to the unique key and can include unique keys corresponding to other tables. By including unique keys from the other tables, the relational database can link rows of one table to rows of the other tables, allowing the relational database to nest stored data based on the relational model.

Accessing nested data in a relational database typically involves multiple application programming interface (API) calls. For example, when a relational database stores data in a three table nesting, the stored data can be accessed by issuing an API call to access a first table and identify a relationship to a second table, issuing another API call to access the second table and identify a relationship to a third table, and issuing yet another API call to access the third table to access stored data. For many relational database applications, issuing multiple API calls to access nested data incurs processing resource and latency penalties that can be overlooked. When an application utilizes relational databases to store deeply nested data and/or to perform a large volume of memory access operations, the utilization of processing resources and latency due to the multiple API calls can become a bottleneck.

### SUMMARY

This application discloses a server configured to receive an expanding memory access request for nested data stored in a memory system having multiple relational tables. The expanding memory access request identifies the relational tables storing the nested data and has a syntax that indicates links between the relational tables storing the nested data. The server parses the expanding memory access request to identify the links between the relational tables that store the nested data, and generates memory access commands based on the identified links. The memory access commands, when provided to the memory system, prompt the memory system to retrieve the nested data from the relational tables for the server. The server generates a response message that includes the nested data in a format specified in the expanding memory access request and transmits the response message to a client device that issued the expanding memory access request to the server. Embodiments of will be described below in greater detail.

### DESCRIPTION OF THE DRAWINGS

FIG. 1 illustrates an example distributed database environment according to various embodiments.

FIGS. 2 and 3 illustrate an example of a computer system of the type that may be used to implement various embodiments of the distributed database environment.

FIG. 4 illustrates an example system for database access with an expanding memory request according to various embodiments.

FIGS. 5A-5D illustrate example relational database tables accessed by an expanding memory request system according to various embodiments.

FIG. 6 illustrates an example flowchart for implementing an expanding memory request to access nested data stored in a database according to various embodiments.

### DETAILED DESCRIPTION

### Illustrative Operating Environment

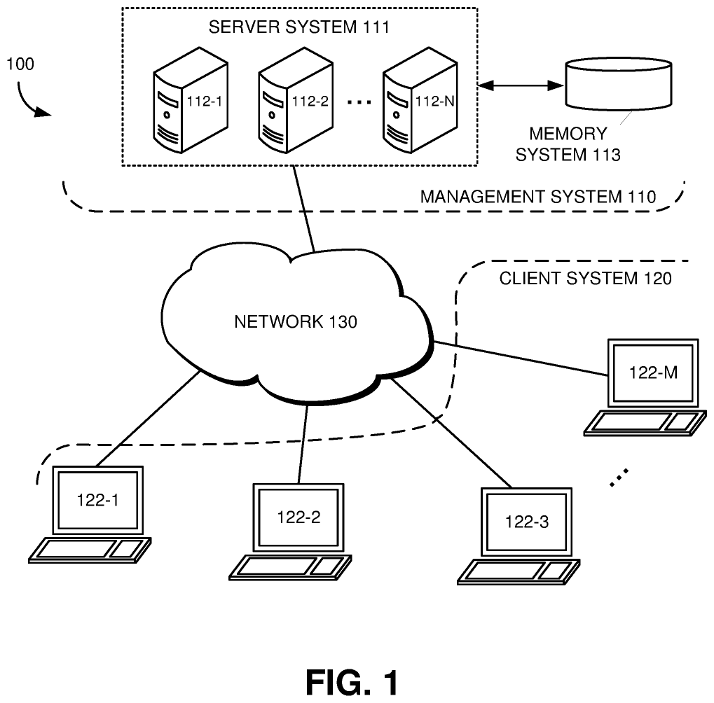

FIG. 1 illustrates an example distributed database system 100 according to various embodiments of the invention. Referring to FIG. 1, the distributed database system 100 includes a server-side, for example, a management system 110, and a client-side, for example, a client system 120, which can communicate with each other over a network 130. The server-side can include the server system 111 to implement the management environment for the client-side of the distributed database system 100. In some embodiments, the server system 111 can include multiple servers 112-1 to 112-N or other processing devices capable of implementing the management environment for the client system 120. The servers 112-1 to 112-N can access a memory system 113, for example, including one or more relational databases, storing data. In some embodiments, the memory system 113 can store self-defining or schema-defined data in a nested format, for example, where the data describes both the structure of the data and the data itself. Embodiments of the self-defining or schema-defined data will be described below in greater detail.

The client-side, for example, a design system 120, can include multiple client devices 122-1 to 122-M, which can communicate with the server system 111 directly or through a network 130. In some embodiments, the client devices 122-1 to 122-M can issue requests to access or mutate data stored by the server system 111 through an application programmable interface (API) implemented by at least one of the servers 112-1 to 112-N. The servers 112-1 to 112-N can utilize the request to access or mutate data the memory system 113. In some embodiments, the servers 112-1 to 112-N can include nested command functionality to receive expanding requests from the client devices 122-1 to 122-M and issue multiple sequential commands to access nested portions of the memory system 113. Embodiments of the expanding requests and the nested command functionality will be described below in greater detail.

In some embodiments, each of the client devices 122-1 to 122-M can implement at least one electronic design automation tool and include a system design management interface (not shown) to communicate with the server system 111. The client devices 122-1 to 122-M can be computers, laptops, workstations, tablets, handsets, or other processing devices capable of communicating with the context server system 111 directly or over the network 130. The network 130 can include one or more packet-switched networks, one or more circuit-switched networks, a combination of both, or the like, which can exchange communication between the server-side and the client-side over wired, wireless, cellular, or any other transmission medium.

The execution of various electronic design automation processes, such as in client devices 122-1 to 122-M, or the management and integration of those processes, such as in server system 111, according to embodiments of the invention may be implemented using computer-executable software instructions executed by one or more programmable computing devices. Because these embodiments of the invention may be implemented using software instructions, the components and operation of a programmable computer system on which various embodiments of the invention may be employed will first be described.

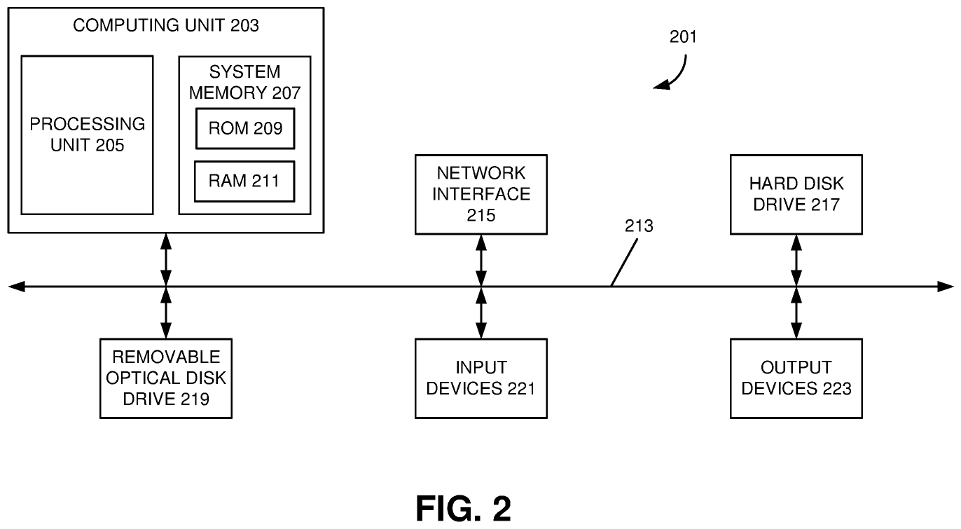

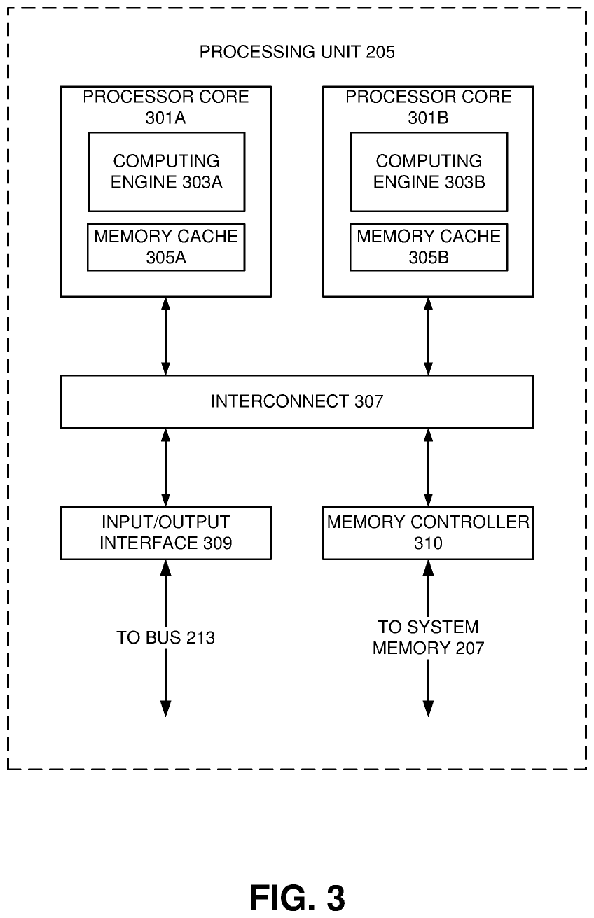

FIGS. 2 and 3 illustrate an example of a computer system that may implement various embodiments of the distributed database system. Referring to FIGS. 2 and 3, various examples may be implemented through the execution of software instructions by a computing device 201, such as a programmable computer. Accordingly, FIG. 2 shows an illustrative example of a computing device 201. As seen in this figure, the computing device 201 includes a computing unit 203 with a processing unit 205 and a system memory 207. The processing unit 205 may be any type of programmable electronic device for executing software instructions, but will conventionally be a microprocessor. The system memory 207 may include both a read-only memory (ROM) 209 and a random access memory (RAM) 211. As will be appreciated by those of ordinary skill in the art, both the read-only memory (ROM) 209 and the random access memory (RAM) 211 may store software instructions for execution by the processing unit 205.

The processing unit 205 and the system memory 207 are connected, either directly or indirectly, through a bus 213 or alternate communication structure, to one or more peripheral devices 215-223. For example, the processing unit 205 or the system memory 207 may be directly or indirectly connected to one or more additional memory storage devices, such as a hard disk drive 217, which can be magnetic and/or removable, a removable optical disk drive 219, and/or a flash memory card. The processing unit 205 and the system memory 207 also may be directly or indirectly connected to one or more input devices 221 and one or more output devices 223. The input devices 221 may include, for example, a keyboard, a pointing device (such as a mouse, touchpad, stylus, trackball, or joystick), a scanner, a camera, and a microphone. The output devices 223 may include, for example, a monitor display, a printer and speakers. With various examples of the computing device 201, one or more of the peripheral devices 215-223 may be internally housed with the computing unit 203. Alternately, one or more of the peripheral devices 215-223 may be external to the housing for the computing unit 203 and connected to the bus 213 through, for example, a Universal Serial Bus (USB) connection.

With some implementations, the computing unit 203 may be directly or indirectly connected to a network interface 215 for communicating with other devices making up a network. The network interface 215 can translate data and control signals from the computing unit 203 into network messages according to one or more communication protocols, such as the transmission control protocol (TCP) and the Internet protocol (IP). Also, the network interface 215 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 201 is illustrated as an example only, and it not intended to be limiting. Various embodiments may be implemented using one or more computing devices that include the components of the computing device 201 illustrated in FIG. 2, which include only a subset of the components illustrated in FIG. 2, or which include an alternate combination of components, including components that are not shown in FIG. 2. For example, various embodiments may be implemented using a multi-processor computer, a plurality of single and/or multiprocessor computers arranged into a network, or some combination of both.

With some implementations, the processor unit 205 can have more than one processor core. Accordingly, FIG. 3 illustrates an example of a multi-core processor unit 205 that may be employed with various embodiments. As seen in this figure, the processor unit 205 includes a plurality of processor cores 301A and 301B. Each processor core 301A and 301B includes a computing engine 303A and 303B, respectively, and a memory cache 305A and 305B, respectively. As known to those of ordinary skill in the art, a computing engine 303A and 303B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 303A and 303B may then use its corresponding memory cache 305A and 305B, respectively, to quickly store and retrieve data and/or instructions for execution.

Each processor core 301A and 301B is connected to an interconnect 307. The particular construction of the interconnect 307 may vary depending upon the architecture of the processor unit 205. With some processor cores 301A and 301B, such as the Cell microprocessor created by Sony Corporation, Toshiba Corporation and IBM Corporation, the interconnect 307 may be implemented as an interconnect bus. With other processor units 301A and 301B, however, such as the Opteron™ and Athlon™ dual-core processors available from Advanced Micro Devices of Sunnyvale, Calif., the interconnect 307 may be implemented as a system request interface device. In any case, the processor cores 301A and 301B communicate through the interconnect 307 with an input/output interface 309 and a memory controller 310. The input/output interface 309 provides a communication interface to the bus 213. Similarly, the memory controller 310 controls the exchange of information to the system memory 207. With some implementations, the processor unit 205 may include additional components, such as a high-level cache memory accessible shared by the processor cores 301A and 301B. It also should be appreciated that the description of the computer network illustrated in FIG. 2 and FIG. 3 is provided as an example only, and it not intended to suggest any limitation as to the scope of use or functionality of alternate embodiments.

### Expanding Memory System Request Implementation

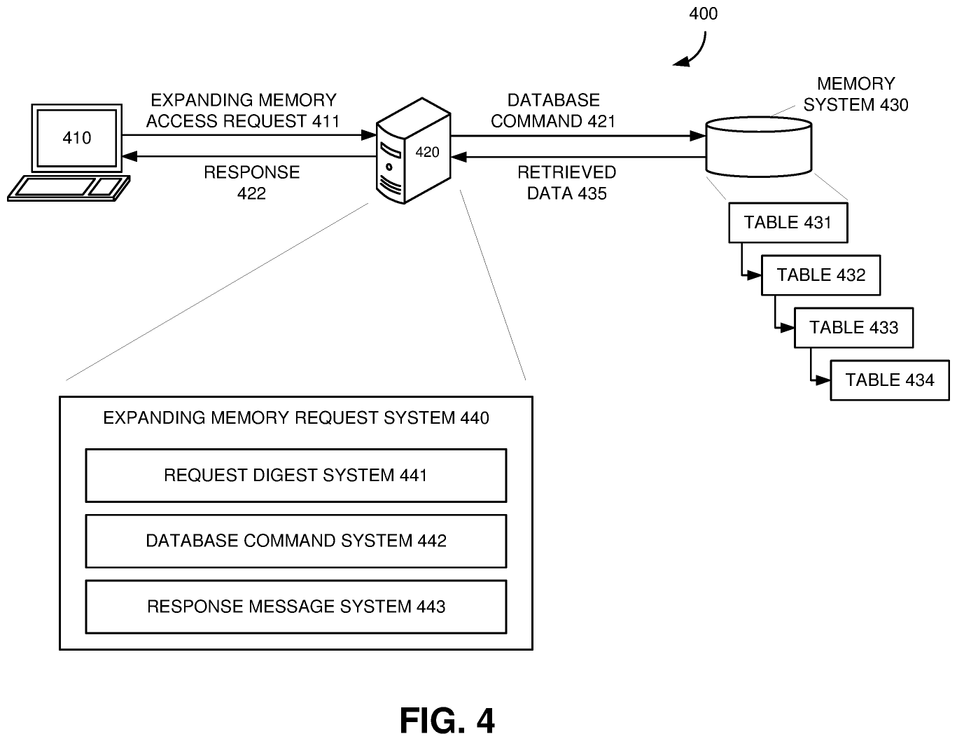

FIG. 4 illustrates an example system 400 for database access with an expanding memory access request 411 according to various embodiments. Referring to FIG. 4, the system 400 includes a client device 410 to access a memory system 430 via a server 420. The client device 410 can be a computer, such as computing device 201, or another electronic device to request access to the memory system 430.

The memory system 430 can include one or more memory devices to store data accessible to the server 420. In some embodiments, the memory system 430 can implement a relational database to store and access data based on a relational model, for example, using a Structured Query Language (SQL) for querying and maintaining the relational database. The relational database can utilize the relational model to organize data into tables 431-434 having a row-column format, with each row having a key or an identifier. The columns of the tables 431-434 can store data corresponding to the identifier and, in some embodiments, can include identifiers corresponding to one or more of the other tables 431-434. By including the identifiers from the other tables, the relational database can link rows of one table to rows of the other tables, allowing the relational database to nest stored data based on the relational model. In some embodiments, the data stored in the relational database can be self-defining or schema-defined data, for example, including schema tables corresponding to the tables 431-434 to define attributes, such as a type of data or identifier stored in the columns of the tables 431-434.

The server 420 can include a computing system, such as computing device 201 or another electronic processing system, to implement an expanding memory request system 440. The expanding memory request system 440 can implement an application programming interface (API), which can allow the server 420 to receive memory access requests, such as an expanding memory access request 411, from the client device 410. The expanding memory access request 411 can identify a plurality of the tables 431-434 in the memory system 430 to access, include an identifier to one of the tables 431-434, identify attributes or columns of the tables 431-434 to access, and have a syntax that indicates an access path between the plurality of the tables 431-434. In some embodiments, the access path between the tables 431-434 can correspond to an identification of which of the tables 431-434 store identifiers or keys to rows in different tables, so the server 420 can access data or identifiers stored in the rows of the different tables.

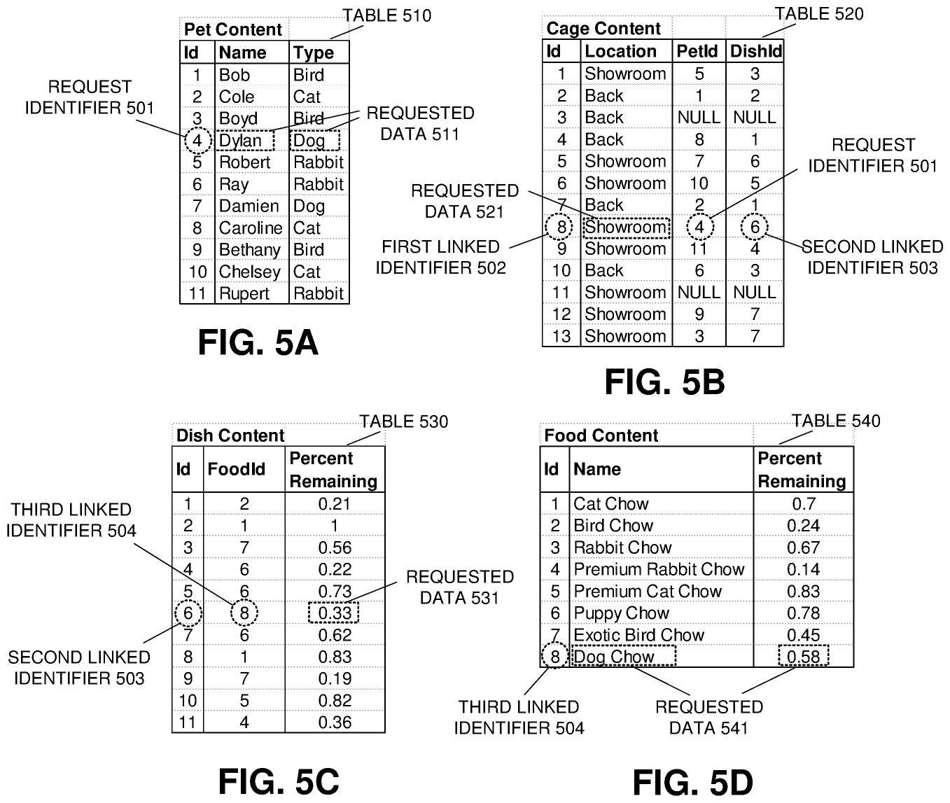

The expanding memory request system 440 can include a request digest system 441 to parse the expanding memory access request 411 to identify which of the tables 431-434 in the memory system 430 to access and ascertain the identifier to a row in one of the tables 431-434 in the memory system 430. The expanding memory request system 440 can identify a type of information stored in the one or more columns of the tables 431-434, such as data to retrieve or an identifier associated with another one the tables 431-434 in the memory system 430. In some embodiments, the request digest system 441 can utilize the indication that columns of tables include identifiers for other tables to identify links between the tables 431-434 identified in the expanding memory access request 411. Embodiments of an expanding memory access request will be described with reference to FIGS. 5A-5D in greater detail.

The expanding memory request system 440 can include a database command system 442 to generate database commands 421 based, at least in part, on the expanding memory access request 411. In some embodiments, the database commands 421 can be formatted according to a Structured Query Language (SQL), which can allow the server to query the tables 431-434 in the memory system 430. The server 420 can transmit the database commands 421 to the memory system 430, which can prompt the memory system 430 to retrieve identifiers and nested data from the tables 431-434.

In some embodiments, the database command system 442 can utilize the identifier in the expanding memory access request 411 to generate a first set of one or more database commands 421 to access one or more columns in a first table in the memory system 430. When the memory system 430, in response to the first set of database commands 421, retrieves data from the one or more columns in the first table, the memory system 430 can provide the retrieved data 435 to the server 420. In some embodiments, the memory system 430 can retrieve an identifier associated with a second table in the memory system 430 in response to the first set of database commands 421.

The database command system 442 can generate a second set of one or more database commands 421 to access one or more columns in the second table in the memory system 430 using the identifier retrieved in response to the first set of the database commands 421. When the memory system 430, in response to the second set of database commands 421, retrieves data from the one or more columns in the second table, the memory system 430 can provide the retrieved data 435 to the server 420. In some embodiments, the memory system 430 can retrieve an identifier associated with a third table in the memory system 430 in response to the second set of database commands 421.

The database command system 442 can generate a third set of one or more database commands 421 to access one or more columns in the third table in the memory system 430 using the identifier retrieved in response to the second set of the database commands 421. When the memory system 430, in response to the third set of database commands 421, retrieves data from the one or more columns in the third table, the memory system 430 can provide the retrieved data 435 to the server 420. In some embodiments, the memory system 430 can retrieve an identifier associated with a fourth table in the memory system 430 in response to the third set of database commands 421. The server 420 can continue to generate database commands 421 to access additional tables identified in the expanding memory access command 411 as storing nested data utilizing identifiers retrieved from other tables in the memory system 430.

The expanding memory request system 440 can include a response message system 443 to generate a response message 422 that includes the retrieved data 435 from the memory system 430. In some embodiments, the response message system 443 can utilize the expanding memory access request 411 to identify a format for the retrieved data 435 and generate the response message 422 to include the retrieved data 435 in the identified format. The response message system 443 can transmit the response message 422 to the client device 410. From the point-of-view of the client device 410, the response message 422 populated with data that was nested within that tables 431-434 of the memory system 430 was received in response to a single memory request, e.g., the expanding memory access request 411, rather than multiple serial API calls. Embodiments of table access based on an expanding memory access request will be described below with reference to FIGS. 5A-5D.

FIGS. 5A-5D illustrate example relational database tables 510-540 accessed by an expanding memory request system according to various embodiments. Referring to FIGS. 5A-5D, an example expanding memory access request is shown below:

var mdotsRequest = {

“4”: {

“Name”,
“Type”,
“inCage”: {

“Location”,
“hasDish” : {

“PercentRemaining”,
“hasFood”: {

“Name”,
“PercentRemaining”

}

}

}

}

};

The example expanding memory access request can include a request identifier 501, shown as “4” in the example expanding memory access request. The request identifier 501 corresponds to a primary key for a row in a table 510 of a memory system. The example expanding memory access request can identify columns of the table 510 by the schema of the table 510—“Name” and “Type”—to retrieve requested data 511 utilizing request identifier 501. In some embodiments, the server can access a schema table associated with the table 510 to determine which of the columns have the schema of “Name” and “Type”. A server receiving the example expanding memory access request can generate at least one database command to access a row corresponding to the request identifier 501 of the table 510 and retrieve the requested data 511 in the columns—“Name” and “Type”—of the table 510. In this example, the memory system can read “Dylan” from the column of the table 510 associated with the “Name,” and read “Dog” from the column of the table 510 associated with the “Type.” The example expanding memory access request can include “inCage” to identify a link to a table 520. The server can generate at least one database command to utilize the request identifier 501 to determine a first linked identifier 502 for the table 520. The first linked identifier 502 corresponds to a primary key for a row in the table 520 of the memory system.

The example expanding memory access request can identify a column of the table 520—“Location”—to retrieve requested data 521 utilizing first linked identifier 502. In some embodiments, the server also can access a schema table associated with the table 520 to determine which of the column has the schema of “Location”. The server can generate at least one database command to access a row corresponding to the first linked identifier 502 of the table 520 and retrieve the requested data 521 in the column associated with the schema—“Location”—of the table 520. In this example, the memory system can read “Showroom” from the column of the table 520 associated with the “Location.” The example expanding memory access request can include “hasDish” to identify that table 520 includes an identifier to table 530 and thus links tables 520 and 530. The server can generate at least one database command to utilize the first linked identifier 502 to access the table 520 to determine a second linked identifier 503 for the table 530. The second linked identifier 503 corresponds to a primary key for a row in the table 530 of the memory system.

The example expanding memory access request can identify a column of the table 530—“PercentRemaining”—to retrieve requested data 531 utilizing second linked identifier 503. In some embodiments, the server also can access a schema table associated with the table 530 to determine which of the column has the schema associated with “PercentRemaining” The server can generate at least one database command to access a row corresponding to the second linked identifier 503 of the table 530 and retrieve the requested data 531 in the “PercentRemaining” column of the table 530. In this example, the memory system can read “0.33” from the “PercentRemaining” column of the table 530. The example expanding memory access request can include “hasFood” to identify the table 530 stores an identifier to a table 540 and thus links tables 530 and 540. The server can generate at least one database command to utilize the second linked identifier 503 to access the table 530 to determine a third linked identifier 504 for the table 540. The third linked identifier 504 corresponds to a primary key for a row in the table 540 of the memory system.

The example expanding memory access request can identify columns of the table 540—“Name” and “PercentRemaining”—to retrieve requested data 541 utilizing third linked identifier 504. In some embodiments, the server also can access a schema table associated with the table 540 to determine which of the columns have schema associated with “Name” and “PercentRemaining”. The server can generate at least one database command to access a row corresponding to the third linked identifier 504 of the table 540 and retrieve the requested data 541 in the “Name” and “PercentRemaining” columns of the table 540. In this example, the memory system can read “Dog Chow” from the “Name” column of the table 540 and read “0.58” from the “PercentRemaining” column of the table 540.

In some embodiments, the server can receive the example expanding memory access request in an API call. An example of the API with the expanding memory access request is shown below:

API.mdots(mdotsRequerst).then(function(mdotsResult) {

console.log(mdotsResult.Name + ‘ the ’ + mdotsResult.Type + ‘ is in the ’ +
mdotsResult.inCage.Location + ‘ and is eating ’ +
mdotsResult.inCage.hasDish.hasFood.Name + ‘ and has ’ +
(mdotsResult.inCage.hasDish.PercentRemaining * 100) + ‘% remaining in the
dish, with ’ + (mdotsResult.inCage.hasDish.hasFood.PercentRemaining *
100) + ‘% remaining in storage’);

};

This example API call can prompt the server to execute the example expanding memory access request to generate the database commands and retrieve the nest data, such as requested data 511, 521, 531, and 541 from tables 510, 520, 530, and 540, respectively. The example API call also includes a format of a response message for the server to generate transmit back to a client system. The server can generate the response message based on the API call, for example, by populating the requested data 511, 521, 531, and 541 into the log script defined by the console.log portion of the API call.

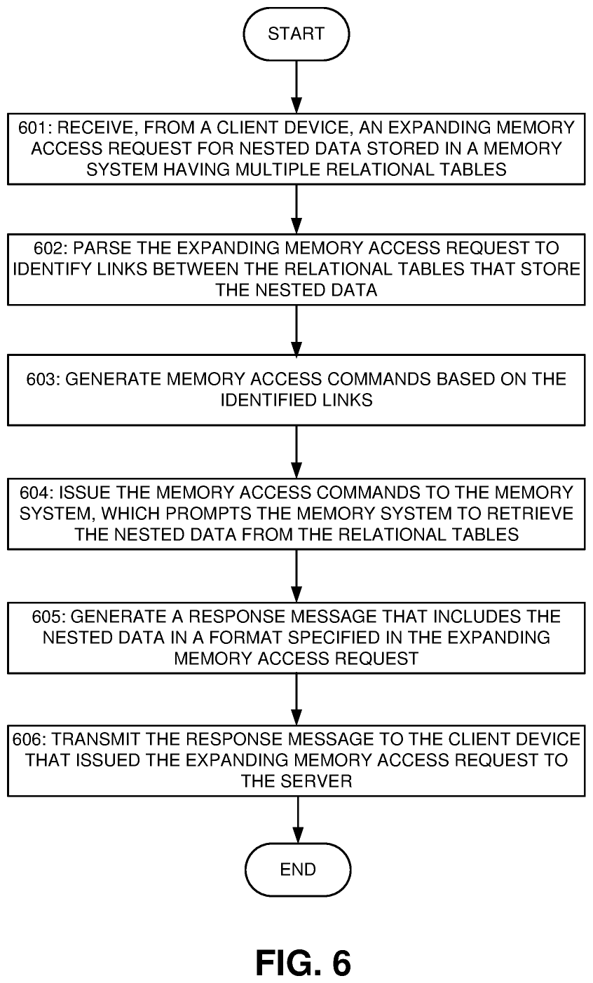

FIG. 6 illustrates an example flowchart for implementing an expanding memory request to access nested data stored in a database according to various embodiments. Referring to FIG. 6, in a block 601, a server can receive, from a client device, an expanding memory access request for nested data stored in a memory system having multiple relational tables. In some embodiments, the server can implement an application programming interface (API), which can allow the client device to transmit the expanding memory access request to the server in a single an API call.

In a block 602, the server can parse the expanding memory access request to identify links between the relational tables that store the nested data. The server can utilize the expanding memory access request to identify a series of the relational tables in the memory system to access, include an identifier to access an initial relational table, and determine how to locate identifiers for each of the relational tables within other relational tables. The server also can utilize the expanding memory access request to identify which columns of the relational tables to access to retrieve data or an identifier for a different relational table.

In a block 603, the server can generate memory access commands based on the identified links and, in a block 604, the server can issue the memory access commands to the memory system. In some embodiments, the memory access commands can be formatted according to a Structured Query Language (SQL), which can allow the server to query the relational tables in the memory system. The server can transmit the memory access commands to the memory system, which can prompt the memory system to retrieve identifiers and nested data from the relational tables.

Since the expanding memory access request identifies an access path that includes reading identifiers from relational tables in order to access other relational tables, the server can generate the memory access commands in series. For example, when the server issues memory access commands to read data and an identifier from one relational table, the server can issue subsequent memory access commands using the read identifier to read data and possibly an identifier from another relational table.

In a block 605, the server can generate a response message that includes the nested data in a format specified in the expanding memory access request. In some embodiments, the server can utilize the expanding memory access request to identify a format for the nested data and generate the response message to include the nested data in the identified format.

In a block 606, the server can transmit the response message to a client device that issued the expanding memory access request to the server. From the point-of-view of the client device, the response message populated with data that was nested within the relational tables of the memory system was received in response to a single API call having an expanding memory access request.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
receiving, by a server, an expanding memory access request for nested data stored in a memory system having multiple relational tables;
parsing, by the server, the expanding memory access request to identify links between the relational tables that store the nested data; and
generating, by the server, memory access commands based, at least in part, on the identified links between the relational tables that store the nested data, wherein the memory access commands, when provided to the memory system, prompt the memory system to retrieve the nested data from the relational tables for the server.

2. The method of claim 1, further comprising:
generating, by the server, a response message that includes the nested data in a format specified in the expanding memory access request; and
transmitting, by the server, the response message to a client device that issued the expanding memory access request to the server.

3. The method of claim 1, wherein each of the relational tables is configured in a row-column format, indexable with identifiers, and wherein parsing the expanding memory access request further comprises identifying a request identifier configured to index one of the relational tables.

4. The method of claim 3, wherein at least one of the memory access commands utilizes the request identifier to access one of the relational tables to retrieve at least one linked identifier configured to index another one of the relational tables.

5. The method of claim 3, wherein parsing the expanding memory access request further comprises determining which of the relational tables stores at least one identifier for at least another one of the relational tables, which defines the links between the relational tables storing the nested data.

6. The method of claim 1, wherein the expanding memory access request identifies the relational tables storing the nested data and has a syntax that indicates the links between the relational tables storing the nested data.

7. The method of claim 1, wherein the memory system implements a relational database to store the nested data in the relational tables based on a relational model.

8. A system comprising:
a memory device configured to store machine-readable instructions; and
a computing system including one or more processing devices, in response to executing the machine-readable instructions, configured to
receive an expanding memory access request for nested data stored in a memory system having multiple relational tables;
parse the expanding memory access request to identify links between the relational tables that store the nested data; and
generate memory access commands based, at least in part, on the identified links between the relational tables that store the nested data, wherein the memory access commands, when provided to the memory system, prompt the memory system to retrieve the nested data from the relational tables.

9. The system of claim 8, wherein the one or more processing devices, in response to executing the machine-readable instructions, are further configured to:
generate a response message that includes the nested data in a format specified in the expanding memory access request; and
transmit the response message to a client device that issued the expanding memory access request.

10. The system of claim 8, wherein each of the relational tables is configured in a row-column format, indexable with identifiers, wherein the one or more processing devices, in response to executing the machine-readable instructions, are further configured to identify a request identifier configured to index one of the relational tables.

11. The system of claim 10, wherein at least one of the memory access commands utilizes the request identifier to access one of the relational tables to retrieve at least one linked identifier configured to index another one of the relational tables.

12. The system of claim 10, wherein the one or more processing devices, in response to executing the machine-readable instructions, are further configured to determine which of the relational tables stores at least one identifier for at least another one of the relational tables, which defines the links between the relational tables storing the nested data.

13. The system of claim 8, wherein the expanding memory access request identifies the relational tables storing the nested data and has a syntax that indicates the links between the relational tables storing the nested data.

14. An apparatus comprising at least one computer-readable memory device storing instructions configured to cause one or more processing devices to perform operations comprising:
receiving an expanding memory access request for nested data stored in a memory system having multiple relational tables;
parsing the expanding memory access request to identify links between the relational tables that store the nested data; and
generating memory access commands based, at least in part, on the identified links between the relational tables that store the nested data, wherein the memory access commands, when provided to the memory system, prompt the memory system to retrieve the nested data from the relational tables.

15. The apparatus of claim 14, wherein the instructions are configured to cause the one or more processing devices to perform operations further comprising:
generating a response message that includes the nested data in a format specified in the expanding memory access request; and
transmitting the response message to a client device that issued the expanding memory access request.

16. The apparatus of claim 14, wherein each of the relational tables is configured in a row-column format, indexable with identifiers, and wherein the instructions are configured to cause the one or more processing devices to perform operations further comprising identifying a request identifier configured to index one of the relational tables.

17. The apparatus of claim 16, wherein at least one of the memory access commands utilizes the request identifier to access one of the relational tables to retrieve at least one linked identifier configured to index another one of the relational tables.

18. The apparatus of claim 16, wherein the instructions are configured to cause the one or more processing devices to perform operations further comprising determining which of the relational tables stores at least one identifier for at least another one of the relational tables, which defines the links between the relational tables storing the nested data.

19. The apparatus of claim 14, wherein the expanding memory access request identifies the relational tables storing the nested data and has a syntax that indicates the links between the relational tables storing the nested data.

20. The apparatus of claim 14, wherein the memory system implements a relational database to store the nested data in the relational tables based on a relational model.
